(19) United States
(12) Patent Application Publication
(10) Pub. No.: US 2003/0097460 A1
(43) Pub. Date: May 22, 2003

(54) Relay apparatus and relay method suitable for performing communication to ensure quality of service

(75) Inventors: Mitsuru Higashiyama, Atsugi-shi (JP); Takahiro Yamaguchi, Atsugi-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Anritsu Corporation, Tokyo (JP)

(21) Appl. No.: 10/298,841

(22) Filed: Nov. 18, 2002

(30) Foreign Application Priority Data
Nov. 22, 2001 (JP) 2001-357848

(51) Int. Cl. G06F 15/16

(52) U.S. Cl. 709/232

(57) ABSTRACT

A detecting section monitors predetermined information included in communication contents transmitted from one node of two communication nodes to detect bandwidth information associated with a required bandwidth for transmitting the communication contents from one node of the two communication nodes to the other node. A bandwidth allocating section makes a determination on whether or not the required bandwidth can be guaranteed based on the bandwidth information detected by the detecting section, and allocates the buffer sections capable of guaranteeing the required bandwidth of a buffer group to the communication contents when determination is that the required bandwidth can be guaranteed.

### CROSS-REFERENCE TO RELATED APPLICATIONS

This application is based upon and claims the benefit of priority from the prior Japanese Patent Application No. 2001-357848, filed Nov. 22, 2001, the entire contents of which are incorporated herein by reference.

### BACKGROUND OF THE INVENTION

1. Field of the Invention

The present invention relates to a relay apparatus and a relay method, and particularly to a relay apparatus and a relay method suitable for performing communication to ensure quality of service when communication such as video streaming, voice/video conference is performed between two communication nodes via the Internet for mutually communicating a packet by connecting a plurality of networks.

2. Description of the Related Art

As well known, the Internet is a computer network using the TCP/IP protocol spread all over the world, and a main role thereof so far is to transmit displays of static Web pages, text-based electronic mails between a server and a client.

However, in recent years, in the Internet, broadbandization has been accelerated against the background of fast access services such as ADSL (Asymmetric Digital Subscriber Line), CATV (cable television, community antenna television).

In this manner, the role of the Internet has been changed as the infrastructure for transferring contents of e-commerce, entertainment or multimedia by broadbandization.

Particularly, with respect to the Internet, video streaming and voice/video conference on various applications are specially emphasized in the field of business and entertainment.

When streaming data such as video streaming, voice/video conference is distributed on the Internet, drop of the packet and confusion of video and voice due to the drop are crucial problems.

Therefore, for the Internet which plays a role for distributing broadbandized multimedia, it is a key point how the quality of service is guaranteed.

In the field of digital leased line conventionally used, there is employed the time division multiplexing method for multiplexing plural items of data by changing a time for sending digital data by constant time (time slot).

In this time division multiplexing method, one user's communication is guaranteed on a communication line at a constant rate.

For example, on the communication line having a capacity of 155 Mbps, up to 100 users can utilize the communication service of 1.5 Mbps.

In other words, in this case, the bandwidth of 155 Mbps is time-divided into 100 channels, and each of 100 channels is allocated to each user.

In this manner, the state where the communication is allocated in the given bandwidth on the communication line is called “bandwidth is guaranteed.”

On the contrary, the Internet uses the packet multiplexing method.

That is, in the case of the Internet, the packets having an address capable of identifying users at the destination and the source by packet are transmitted on the line.

Therefore, the concept of physical channel is not present on the line of the Internet, the packets of all the users are mixed up to the limit of the capacity of the line or the device, and transmitted on the line of the Internet.

Accordingly, when communications of a plurality of users are mixed and the capacity of the line or the device is exceeded, any data of every user is uniformly disposed when the capacity of the line or the device is exceeded.

In this manner, when the entire communication capacity is available, the Internet can be used as the user desires. But, when the communication capacity is exceeded, the communication is disposed irrespective of the contents of the communication when the communication capacity is exceeded.

Such a method is called a “best effort.”

Since the Internet adopted in 1950 was originally a network for experiments or researches, the “best effort” could be accepted by the concerned persons.

However, in 1990s, as the Internet is used for business, necessity of control of the quality of service (which will be simply denoted as QoS) has strongly been desired.

In order to realize the control of the QoS on the Internet, two methods of IntServ (Integrated Service) and DiffServ (Differentiated Service) have been considered mainly by researchers or device makers.

The IntServ employs a method for allocating a requested bandwidth and quality for each communication on the communication line like the digital leased line or ATM (asynchronous transfer mode).

In this IntServ, each communication is called a flow.

In this flow, for example, a transfer of a file X performed between persons A and B is assumed to be one unit.

Therefore, when the persons A and B transfer another file Y, another flow is allocated.

A control protocol of RSVP (ReSouece reservation Protocol) is used for allocating of a bandwidth in the IntServ.

This RSVP is a higher protocol of the TCP/IP defined in the RFC2205 for guaranteeing resources such as a bandwidth, a buffer, and the like between two points via the Internet and realizing the QoS control.

This RSVP is exchanged between a transmitting node and a admission node, but routers provided in the halfway path of exchanging check the contents thereof, and perform bandwidth setting of buffer queues for communication owned by the routers and the line.

FIGS. 12 and 13 are schematic explanatory diagrams when bandwidth guaranteeing is applied by the RSVP between the transmitting node and the admission node.

As shown in FIG. 12, the transmitting node transmits a Path message as a request message for bandwidth reserving in the direction of the admission node before the actual transmitting is started.

The Path message is transferred along the actual transmitting path to the admission node from one router to another router.

When the Path message sequentially transferred through the routers is received, the admission node makes preparations for admission data of the requested bandwidth.

As shown in FIG. 13, the admission node transmits a Resv message in the direction opposite to the Path message.

The Resv message is also transferred to the transmitting node from one router to another router.

At this time, each router which has received the Resv message performs guaranteeing of the actually requested bandwidth.

The guaranteeing of the bandwidth is performed by allocating the capacity capable of processing the requested bandwidth to the buffer queue for transmitting/admission in the router.

Each router sets the setting of the schedule of the buffer queue to the requested quality of service.

In the case of the network connected to the line capable of guaranteeing the QoS such as the ATM, the bandwidth reserving of the line is also performed at the same time.

In this manner, the IntServ is a technique excellent in performing the guaranteeing of the bandwidth by flow and finely controlling the setting of the bandwidth or the setting of the quality.

However, such an IntServ has a problem that “the RSVP is not scaled” when the RSVP is applied on the Internet.

For example, when the number of flows is within hundred to thousand figures, the RSVP can sufficiently function.

However, in the Internet, in consideration of the center potion called a core, the number of flows reaches several millions to tens of millions of figures.

In such a case, the routers in the Internet core have to transmit/receive reservations of a large number of RSVP packets and open packets, and internally manage the flows thereof so that processing performance cannot endure.

Further, the RSVP is exchanged in the end-end manner of the communication nodes, but all the routers in the halfway path have to support the RSVP.

The Internet is configured so that several thousands of Internet provides are connected in a finely meshed pattern.

Therefore, there is a problem that, if only one router which one provide uses does not support the RSVP, the RSVP itself does not function.

In this manner, the IntServ has excellent functions, but is not sufficiently supported in the Internet operated in every provider.

On the contrary, the DiffServ is a method which was produced as the QoS technique applicable to the Internet by researchers confronting the problem that “the RSVP is not scaled” in the IntServ.

This DiffServ is one of the QoS control techniques on the TCP/IP network, and is a method redefined for marking code points for discriminating a traffic class of the region of TOS (Type Of Service) with 8 bits in the IP header as shown in the format of the IP data block in FIG. 14.

In such a DiffServ, it is defined to have the PHB (Per Hop Behavior) traffics and 64 buffer queues corresponding thereto at maximum.

In each PHB, the characteristics that “the bandwidth is large and the delay is small” and “the bandwidth is small and the delay is large” are determined by attribute of the buffer queue.

With respect to the packet passing through the DiffServ, it is determined in advance by which traffic characteristic the communication is performed, and the code point corresponding to the PHB is marked.

The DiffServ has the background of having been developed for “the quality of service better than the best effort.”

Therefore, the bandwidth is not guaranteed in the DiffServ so that, even if the DiffServ has the code point with high priority, when a large amount of traffics using the PHB are flowed, congestion finally occurs and drop of the packet occurs.

Further, even in the PHB in which the drop rate of the packet is small, the drop rate is not 0 and the bandwidth is not guaranteed.

The video streaming and the voice/video conference operate more complicatedly as compared with other Web (HTTP) or e-mail (POP3/SMTP).

In the case of the video streaming and the voice/video conference, communication for connecting management of the control session is performed between the communication nodes at first, where exchange of parameter for passing video or voice data and preparations for the both are performed in many cases.

This communication for connecting management requires to be set in a predetermined signaling method called a signaling between the communication nodes.

At the stage where the preparations are made between the communication nodes, the data session for passing video or voice is started.

As an application for stream distribution such as the video or voice, there is known an application for performing communication by a control session protocol of RTSP and a data session protocol of RTP.

FIG. 15 shows a procedure when data communication is performed between a client and a server by the above application for stream distribution.

As shown in FIG. 15, the RTSP of the above application notifies a bandwidth (which is given as a bit rate in a character string in the RTSP (Attribute/Bandwidth)) requested for the data before the data session is started, and notifies the UDP port number used for the data session from the client.

When the preparations for creating the RTP session are made, the UDP packet is started to transmit from the server to the client for the port number which has been notified in advance from the client.

However, in the best effort network where the bandwidth is not guaranteed, there is a problem that the RTP packet is lost in the halfway path during congestion, and the ending occurs due to deterioration of the quality of video or voice, or the timeout of the application itself so that the quality of service is lost.

### BRIEF SUMMARY OF THE INVENTION

It is an object of the present invention to provide a relay apparatus and a relay method in which a burden on user setting is not increased, signaling for the QoS control between communication nodes such as the RSVP is not required, and a required bandwidth for communication can be automatically guaranteed so as not to lose the QoS.

In order to achieve the above object, according to a first aspect of the present invention, there is provided a communication apparatus for relaying communication between two communication nodes, comprising:

a detecting section which monitors predetermined information included in communication contents transmitted from one node of the two communication nodes and detects bandwidth information associated with a required bandwidth for transmitting the communication contents from one node of the two communication nodes to another node;

a buffer group including buffer sections capable of guaranteeing the required bandwidth for transmitting the communication contents from one node of the two communication nodes to the other node;

a bandwidth allocating section which makes a determination on whether or not the required bandwidth can be guaranteed based on the bandwidth information detected by the detecting section, and the determination is that the required bandwidth can be guaranteed, allocates the buffer sections capable of guaranteeing the required bandwidth of the buffer group to the communication contents; and

a transmitting section which transmits the communication contents to the other node of the two communication nodes via buffer sections capable of guaranteeing the required bandwidth of the buffer group allocated by the bandwidth allocating section.

According to a second aspect of the present invention, there is provided a communication apparatus according to the first aspect, wherein, when communication is performed between the two communication nodes, the bandwidth allocating section includes a packet classifier which makes an identification on whether or not a packet included in the communication contents received via the one node is a flow which is a guaranteeing target of the required bandwidth, and a flow table having stored therein data indicating a correspondence relationship between the flow which is the guaranteeing target of the required bandwidth and an output queue of the buffer group, and

the packet classifier refers to the flow table to make identification on whether or not the packet is the flow which is the guaranteeing target of the required bandwidth, and stores the packet in buffer sections capable of guaranteeing the required bandwidth of the buffer group when the identification is that the packet is the flow which is the guaranteeing target of the required bandwidth.

According to a third aspect of the present invention, there is provided a communication apparatus according to the second aspect, wherein the transmitting section includes a packet scheduler which performs output scheduling based on data stored in a traffic management database in which data indicating a bandwidth and a delay required for transmitting the packet included in the communication contents allocated to the buffer sections capable of guaranteeing the required bandwidth is stored by queue ID of the flow table.

According to a fourth aspect of the present invention, there is provided a communication apparatus according to the second aspect, wherein the detecting section includes a control session analyzing section which detects information on the required bandwidth for a data session on reception of a packet of a control session from the packet classifier.

According to a fifth aspect of the present invention, there is provided a communication apparatus according to the fourth aspect, wherein the control session analyzing section makes a determination on whether or not the packet is a novel session, and extracts data session information based on the determination.

According to a sixth aspect of the present invention, there is provided a communication apparatus according to the fifth aspect, wherein the control session analyzing section makes a determination on whether or not an application is an application for pre-configured bandwidth setting based on a destination or source port number of the control session, and performs setting of the required bandwidth based on bandwidth information corresponding to a medium type of the data session information when the determination is that the application is an application for pre-configured bandwidth setting.

According to a seventh aspect of the present invention, there is provided a communication apparatus according to the sixth aspect, wherein the control session analyzing section refers to a pre-configured bandwidth information database by application having stored therein data indicating a pre-configured bandwidth predetermined according to each medium type, included in an application to be used to make a determination on whether or not an application with which a data session is exchanged is an application in which pre-configured bandwidth setting is performed, and performs setting of the required bandwidth using bandwidth information read from the pre-configured bandwidth information database by application based on the determination.

According to an eighth aspect of the present invention, there is provided a communication apparatus according to the seventh aspect, wherein the bandwidth allocating section includes a reservation admission control section which performs reservation admission control of the required bandwidth based on data session information input from the control session analyzing section.

According to a ninth aspect of the present invention, there is provided a communication apparatus according to the eighth aspect, wherein the reservation admission control section makes a determination on whether or not a required bandwidth included in data session information from the control session analyzing section is acceptable, when the determination is that the required bandwidth is acceptable, refers to a session list of the flow table to make a determination on whether or not the required bandwidth is an already reserved data session, and when the determination is that the required bandwidth is an already reserved data session, reserves the required bandwidth to perform resetting.

According to a tenth aspect of the present invention, there is provided a communication apparatus according to the ninth aspect, wherein the reservation admission control section makes a determination on whether or not the required bandwidth is acceptable by referring to used bandwidths registered in a traffic management database.

In order to achieve the above object, according to an eleventh aspect of the present invention, there is provided a communication method for relaying communication between two communication nodes, comprising:

monitoring predetermined information included in communication contents transmitted from one node of the two communication nodes and detecting bandwidth information associated with a required bandwidth for transmitting the communication contents from one node of the two communication nodes to another node;

preparing a buffer group including buffer sections capable of guaranteeing the required bandwidth for transmitting the communication contents from one node of the two communication nodes to the other node;

when a determination is made on whether or not the required bandwidth can be guaranteed based on the bandwidth information and the determination is that the required bandwidth can be guaranteed, allocating the communication contents to buffer sections capable of guaranteeing the required bandwidth of the buffer group; and

transmitting the communication contents to the other node of the two communication nodes via buffer sections capable of guaranteeing the required bandwidth of the buffer group.

According to a twelfth aspect of the present invention, there is provided a communication method according to the eleventh aspect, wherein, when communication is performed between the two communication nodes, the allocating makes an identification on whether or not a packet included in the communication contents received via the one node is a flow which is a guaranteeing target of the required bandwidth by referring to a flow table having stored therein data indicating a correspondence relationship between a flow which is a guaranteeing target of the required bandwidth and an output queue of the buffer group, and stores the packet in buffer sections capable of guaranteeing the required bandwidth of the buffer group when the identification is that the packet is a flow which is a guaranteeing target of the bandwidth.

According to a thirteenth aspect of the present invention, there is provided a communication method according to the twelfth aspect, wherein the transmitting is performed by conducting output scheduling based on data in a traffic management database in which data indicating a bandwidth and a delay required for transmitting the packet included in the communication contents allocated to buffer sections capable of guaranteeing the required bandwidth is stored by queue ID of the flow table.

According to a fourteenth aspect of the present invention, there is provided a communication method according to the twelfth aspect, wherein the detecting includes control session analysis for detecting information on the required bandwidth for a data session on reception of a packet of a control session included in the communication contents.

According to a fifteenth aspect of the present invention, there is provided a communication method according to the fourteenth aspect, wherein the control session analysis makes a determination on whether or not the packet is a novel session, and extracts data session information based on the determination.

According to a sixteenth aspect of the present invention, there is provided a communication method according to the fifteenth aspect, wherein the control session analysis makes a determination on whether or not an application is an application for pre-configured bandwidth setting based on a destination or source port number of the control session, and performs setting of the required bandwidth based on bandwidth information corresponding to a medium type of the data session information when the determination is that the application is an application for pre-configured bandwidth setting.

According to a seventeenth aspect of the present invention, there is provided a communication method according to the sixteenth aspect, wherein the control session analysis refers to a pre-configured bandwidth information database by application having stored therein data indicating a pre-configured bandwidth predetermined according to each medium type, included in an application to be used to determine whether or not an application with which a data session is exchanged is an application in which pre-configured bandwidth setting is performed, and performs setting of the required bandwidth using bandwidth information read from the pre-configured bandwidth information database by application.

According to an eighteenth aspect of the present invention, there is provided a communication method according to the seventeenth aspect, wherein the allocating performs reservation admission control of the required bandwidth based on data session information obtained by the control session analysis.

According to a nineteenth aspect of the present invention, there is provided a communication method according to the eighteenth aspect, wherein the reservation admission control makes a determination on whether or not a required bandwidth included in data session information obtained by the control session analysis is acceptable, when the determination is that the required bandwidth is acceptable, makes a determination on whether or not the required bandwidth is an already reserved data session by referring to a session list of the flow table and when the determination is that the required bandwidth is an already reserved data session, reserves the required bandwidth to perform resetting.

According to a twentieth aspect of the present invention, there is provided a communication method according to the nineteenth aspect, wherein the reservation admission control makes a determination on whether or not the required bandwidth is acceptable by referring to used bandwidths registered in a traffic management database.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a functional block diagram showing one embodiment of a relay apparatus and a relay method according to the present invention;

FIG. 2 is a diagram showing an example of an internal structure of a flow table of FIG. 1;

FIG. 3 is a diagram showing an example of an internal structure of a traffic management database of FIG. 1;

FIG. 4 is a diagram showing an example of an internal structure of a pre-configured bandwidth information database by application of FIG. 1;

FIG. 5 is a flowchart illustrated for explaining operations of a control session analyzing section of FIG. 1;

FIG. 6 is a flowchart illustrated for explaining operations of a reservation admission control section of FIG. 1;

FIG. 7 is a diagram for explaining one example of operations for a RTSP session by the relay apparatus of FIG. 1;

FIG. 8 is a diagram for explaining an example of operations for the RTSP session succeeding to FIG. 7 by the relay apparatus of FIG. 1;

FIG. 9 is a diagram for explaining an example of operations for the RTSP session succeeding to FIG. 8 by the relay apparatus of FIG. 1;

FIG. 10 is a diagram showing an example of an internal structure of the flow table after a novel session is registered in the flow table of FIG. 1;

FIG. 11 is a diagram showing an example of an internal structure of the traffic management database after a novel session is registered in the flow table of FIG. 1;

FIG. 12 is a schematic explanatory diagram showing a case where bandwidth guaranteeing is applied by an RSVP between a transmitting node and a admission node as a prior art;

FIG. 13 is a schematic explanatory diagram showing the case where bandwidth guaranteeing is applied by an RSVP between a transmitting node and a admission node as a prior art;

FIG. 14 is a diagram showing a format of an IP data block in a DiffServ as a prior art;

FIG. 15 is a diagram showing an example of a procedure when data communication is performed between a client and a server by an application for performing communication by RTSP and RTP as a prior art; and

FIG. 16 is a diagram showing an example of a procedure of call establishment and data transmission by H.323 applied as another embodiment of a relay apparatus and a relay method according to the present invention.

### DETAILED DESCRIPTION OF THE INVENTION

Reference will now be made in detail to the presently preferred embodiments of the invention as illustrated in the accompanying drawings, in which like reference numerals designate like or corresponding parts.

At first, an outline of a relay apparatus and relay method according to the present invention will be described.

In the relay apparatus and relay method according to the present invention, communication contents between two communication nodes are monitored and required bandwidth information is detected from the monitored communication contents. A determination is made on whether or not bandwidth guaranteeing of a data session is allowed from data session information including the detected required bandwidth information. When it is determined that the bandwidth guaranteeing is allowed, allocating of the bandwidth to an internal buffer is performed.

Further, in the relay apparatus and relay method according to the present invention, when the bandwidth to be allocated to an application to be used has been already determined by user setting, information of a data flow is detected from the communication contents of a control flow of the application between the two communication nodes. A determination is made on whether or not the bandwidth guaranteeing of the data session is allowed from the data session information including bandwidth information according to the setting of the application based on this detection result. When it is determined that the bandwidth guaranteeing is allowed, allocating of the bandwidth to the internal buffer is performed.

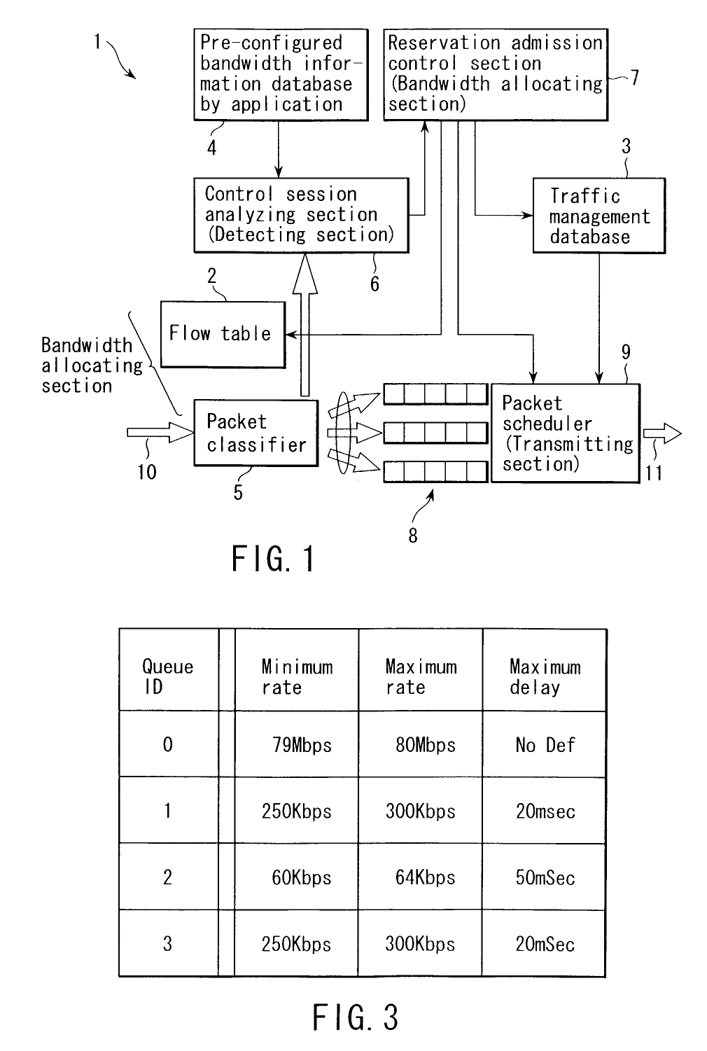

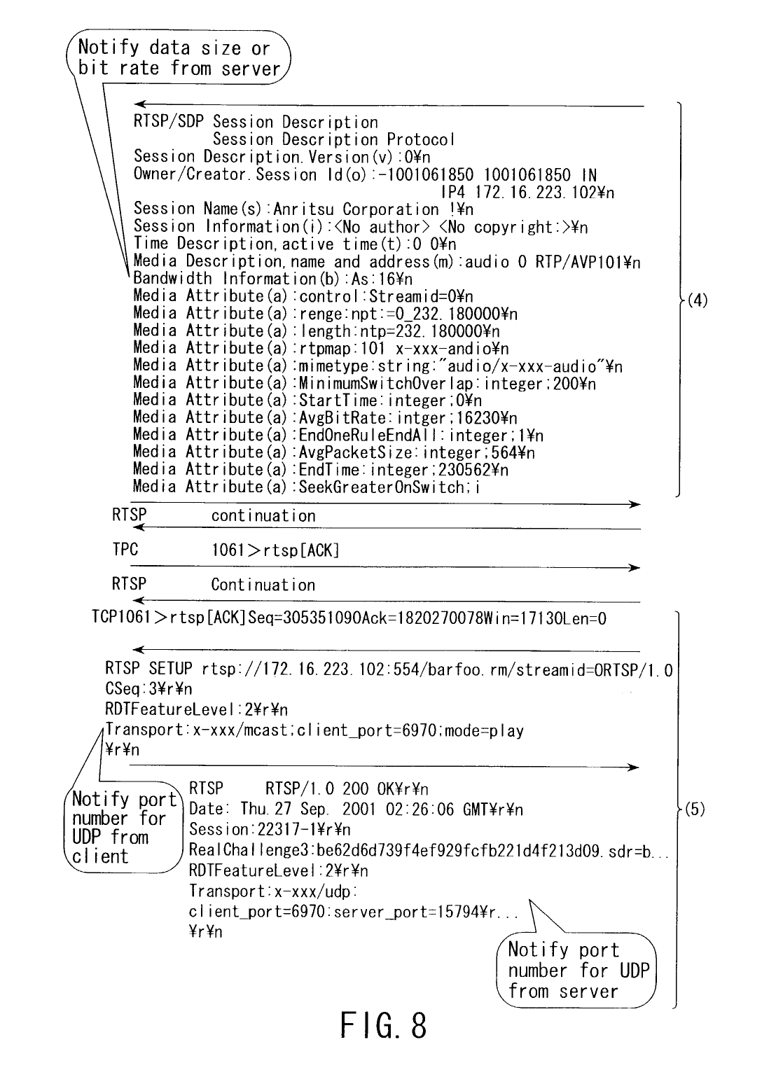

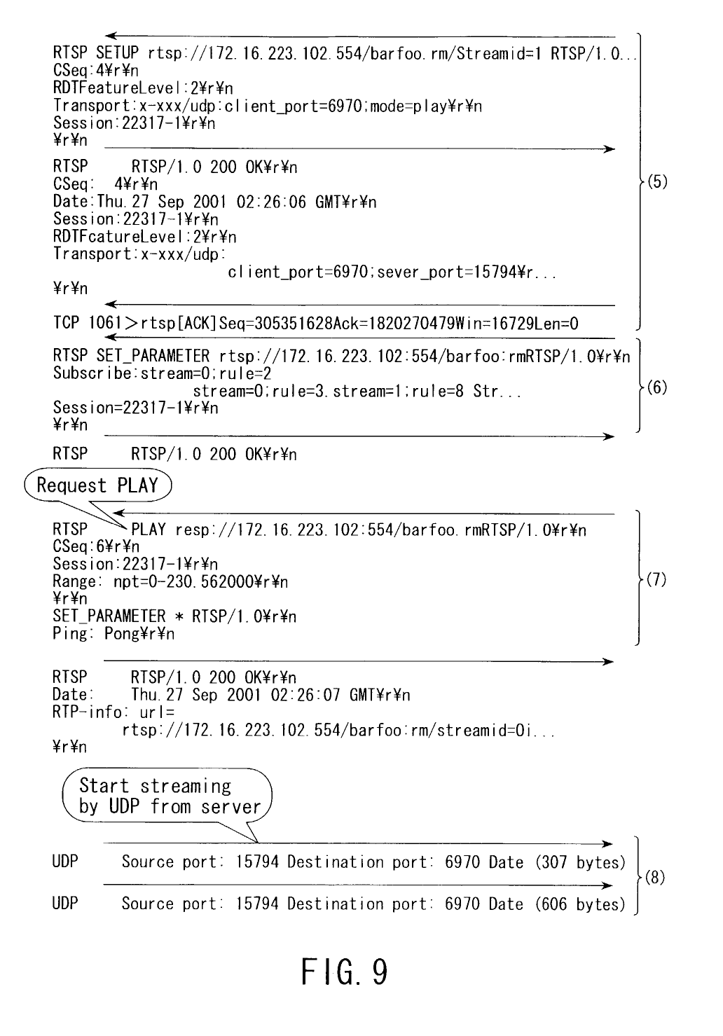

Next, one embodiment of the relay apparatus and relay method according to the present invention on the basis on the above outline will be described with reference to FIGS. 1 to 11.

That is, as shown in FIG. 1, at least one of relay apparatus 1 according to one embodiment of the present invention is connected between two communication nodes 10 and 11 such as a server and a client in a network such as, for example, the Internet.

The relay apparatus 1 comprises a flow table 2, a traffic management database 3, a pre-configured bandwidth information database by application 4 (this database may be omitted), a packet classifier 5, a control session analyzing section (detecting section) 6 as detecting means, a reservation admission control section (bandwidth allocating section) 7 as bandwidth allocating means, a buffer queue (internal buffer, buffer group) 8 as buffer means, and a packet scheduler (transmitting section) 9 as transmitting means.

The buffer queue (internal buffer, buffer group) 8 as buffer means includes buffer sections capable of guaranteeing a bandwidth required for transmitting the communication contents from one node of the two communication nodes to the other node.

Further, the flow table 2 and the packet classifier 5 also configure the bandwidth allocating section as bandwidth allocating means.

The flow table 2 has stored therein data indicating a correspondence relationship between a flow which is a target of the bandwidth guaranteeing and an output queue of the buffer queue 8.

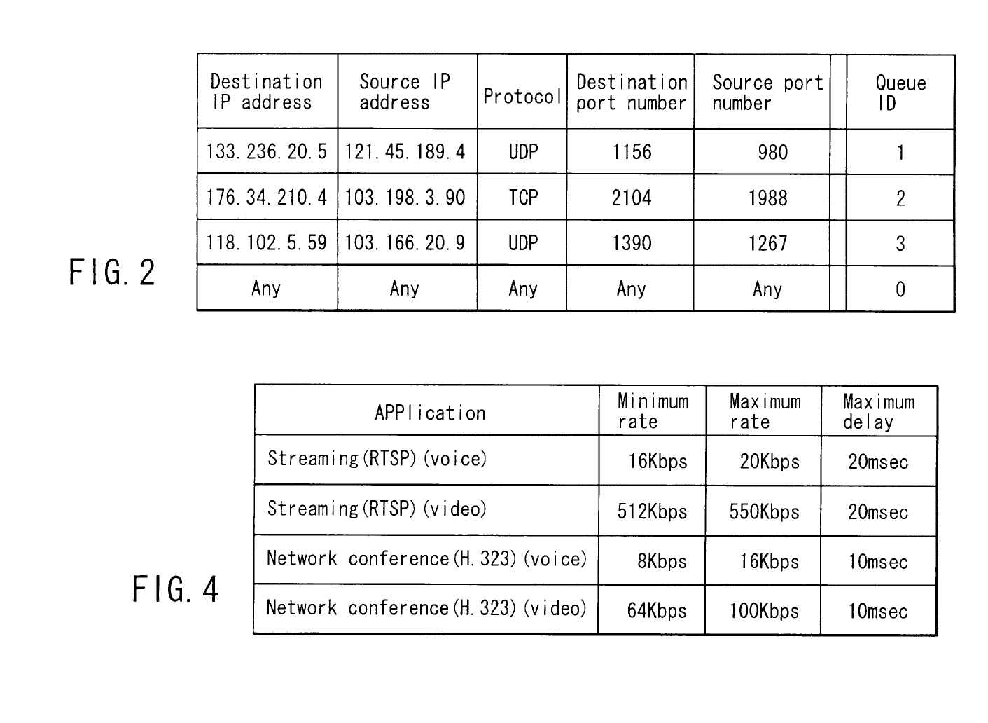

Specifically, one queue ID (QueueID) is allocated to each item of data session information of the flow whose bandwidth is guaranteed, which is stored in the flow table 2, as shown in FIG. 2.

In the example of FIG. 2, the data session information is configured by five components of a destination IP address (for example, 133.236.20.5), a source IP address (for example, 121.45.189.4), a protocol (for example, UDP), a destination port number (for example, 1156), and a source port number (for example, 890).

These five components are assumed to be one set, and one queue ID is allocated to each set.

The queue ID corresponds to the output queue of the buffer queue 8.

Further, data indicating a required bandwidth and a delay is stored in the traffic management database 3 by queue ID of the flow table 2 as shown in FIG. 3.

In the example of FIG. 3, data indicating the minimum communication rate, the maximum communication rate, and the maximum communication delay (time) set for each queue ID of the flow table 2 is stored in this traffic management database 3 in the form of table.

Furthermore, the pre-configured bandwidth information database by application 4 has stored therein data indicating a pre-configured bandwidth predetermined according to medium types such as video, voice, application used for reproducing a video, video/voice included in the application as shown in FIG. 4.

In the example of FIG. 4, data indicating the minimum communication rate, the maximum communication rate, and the maximum communication delay (time) set for each application is stored in the pre-configured bandwidth information database by application 4 in the form of table.

Further, when communication is performed between the two communication nodes 10 and 11, the packet classifier 5 refers to the flow table 2 to identify whether or not the packet included in the communication contents received via one communication node 10 is a flow which is a target of the bandwidth guaranteeing.

The packet classifier 5 stores the packet into the buffer queue 8 dedicated to the bandwidth guaranteeing flow based on the discrimination result, and transmits the packet to the control session analyzing section 6.

Here, in the buffer queue 8 dedicated to the bandwidth guaranteeing flow, the amount of minimum output of the data per unit time is guaranteed.

The packet queued in this buffer queue 8 is output-scheduled by the packet scheduler 9 based on the data in the traffic management database 3, and is transmitted for another communication node 11.

In addition, when the packet of the control session is received, the packet classifier 5 copies the packet of the control session, and transmits the copied packet to the control session analyzing section 6.

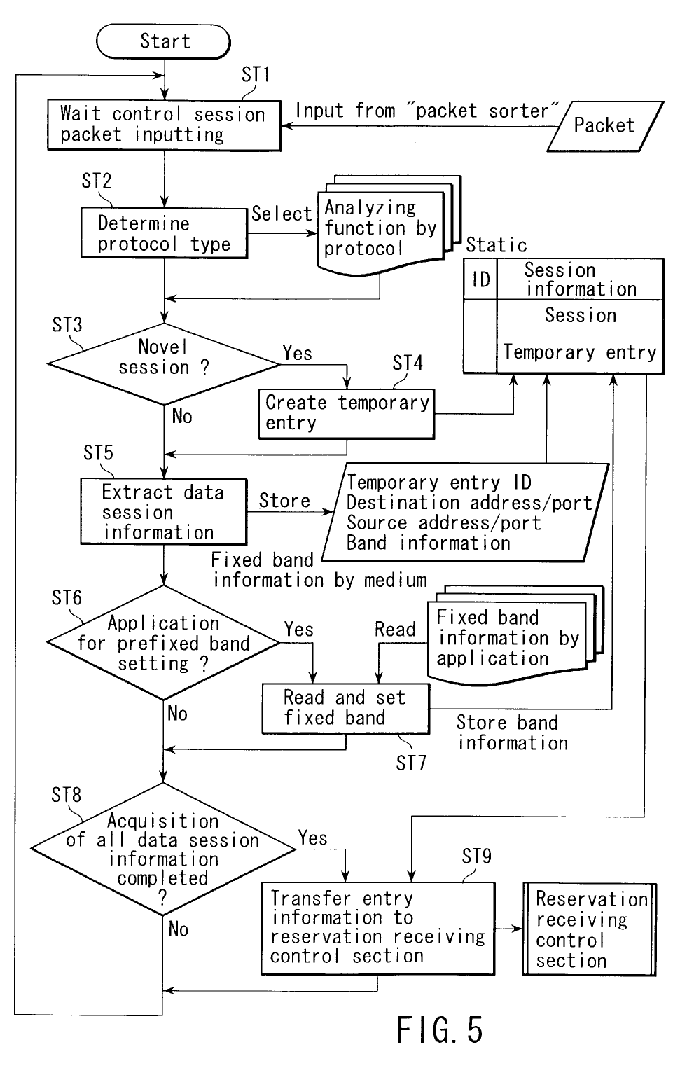

The control session analyzing section 6 traces the packet transmitted from the packet classifier 5, and detects information on the required bandwidth for the data session according to a processing procedure of a flowchart shown in FIG. 5.

Hereinafter, operations of the control session analyzing section 6 will be described based on the flowchart shown in FIG. 5.

The control session analyzing section 6 is generally set to be in a control session packet input wait state from the packet classifier 5 (step ST1).

In the control session packet input wait state, when the packet is input from the packet classifier 5, the control session analyzing section 6 identify the protocol type (for example, RTSP) of the packet (step ST2).

The determination of the protocol type is made by an analyzing function by protocol which is separately prepared in the control session analyzing section 6 by protocol in advance.

Next, when the protocol type of the packet is determined, the control session analyzing section 6 determines whether or not the packet is a novel session (step ST3).

Then, when the packet is a novel session, the control session analyzing section 6 creates a temporary entry based on the session information (for example, the IP address and the port number of the client, the IP address and the port number of the server when the destination port or the source port of the packet for session establishing is the RTSP) (step ST4), and extracts the session information from the packet (step ST5).

On the contrary, when the packet is not a novel session, the control session analyzing section 6 immediately extracts the data session information from the packet (step ST5).

Here, the data session information extracted from the packet is information on the bandwidth required for the destination IP address/port, the source IP address/port, and the session, for example.

When the data session information is extracted in such a manner, the control session analyzing section 6 stores the extracted data session information in an internal memory (not shown).

Subsequently, the control session analyzing section 6 determines whether or not the application is an application for pre-configured bandwidth setting (step ST6, this step may be omitted).

Here, the determination of the application type is made based on the destination or source port number of the control session.

Specifically, the control session analyzing section 6 refers to the pre-configured bandwidth information database by application 4 to determine whether or not the application with which the data session is exchanged is an application in which the pre-configured bandwidth setting is performed.

When the application is an application for pre-configured bandwidth setting, the control session analyzing section 6 reads the bandwidth information corresponding to the medium (for example, voice, video) of the data session information from the pre-configured bandwidth information database by application 4, and performs setting of the bandwidth using the read bandwidth information (step ST7).

The data session information obtained from the above processing is allocated with the ID per data session information together with the already created entry information, and is stored in the internal memory (not shown) of the control session analyzing section 6 in a static manner.

Thereafter, the control session analyzing section 6 determines whether or not acquisition of all the data session information has been completed (step ST8).

When the acquisition of all the data session information is completed, the control session analyzing section 6 transmits the entry information stored in the internal memory (not shown) to the reservation admission control section 7 (step ST9).

On the contrary, when the acquisition of all the data session information is not completed, the control session analyzing section 6 returns to the control session packet input wait state (step STI).

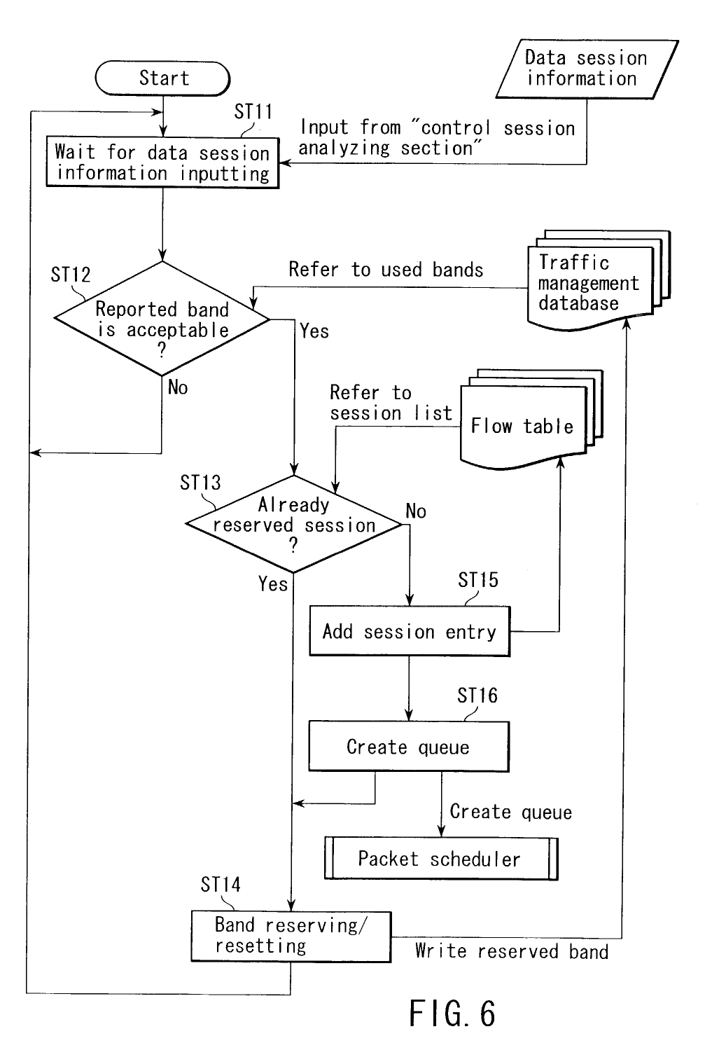

The reservation admission control section 7 operates according to a processing procedure of a flowchart shown in FIG. 6 based on the data session information (entry information) input from the control session analyzing section 6.

Hereinafter, operations of the reservation admission control section 7 will be described based on the flowchart shown in FIG. 6.

The reservation admission control section 7 is generally set to be in a data session information input wait state (step ST11).

In this data session information input wait state, when the data session information is input from the control session analyzing section 6, the reservation admission control section 7 determines whether or not a required bandwidth included in this data session information is acceptable (step ST12).

Here, the determination on whether or not the required bandwidth is acceptable is made by referring to used bandwidths registered in the traffic management database 3.

When the required bandwidth is not acceptable, the reservation admission control section 7 returns to the data session information input wait state (step ST11).

On the contrary, when the required bandwidth is acceptable, the reservation admission control section 7 refers to a session list of the flow table 2 to determine whether or not the required bandwidth is an already reserved data session (step ST13).

When the required bandwidth is an already reserved data session, the reservation admission control section 7 reserves the bandwidth to perform resetting (step ST14), and then returns to the data session information input wait state (step ST11).

On the contrary, when the required bandwidth is not an already reserved data session, the reservation admission control section 7 adds a session entry to the flow table 2 to update the flow table 2 in step ST15, and transmits the queue newly created in step ST16 to the packet scheduler 9.

The reservation admission control section 7 reserves the bandwidth to perform resetting after the creation of the queue (step ST14), writes and updates the reserved bandwidth in the traffic management database 3, and returns to the data session information input wait state (step ST11).

The packet scheduler 9 schedules the buffer queue 8 dedicated to the bandwidth guaranteeing flow in which the amount of minimum output of the data per unit time is guaranteed based on the data stored in the traffic management database 3.

Here, the flow means a flow in a single direction of a packet required to be relayed while guaranteeing a predetermined bandwidth in the relay apparatus 1 according to the present embodiment present on the passing path among a series of packet groups to be transmitted from an application at a specific source terminal to an application at a specific destination terminal.

As described above, in the relay apparatus 1 according to the present embodiment, in input/output processing, at first sorting processing of a series of packet groups included in the received communication contents is sequentially performed by the packet classifier 5.

In this case, the packet classifier 5 refers to the flow table 2. When the packet is a flow which is a target of the bandwidth guaranteeing, the flow is stored in the buffer queue 8 dedicated to the bandwidth guaranteeing flow.

The buffer queue 8 dedicated to the bandwidth guaranteeing flow is guaranteed with respect to the amount of minimum output of the data per unit time.

A series of packet groups sequentially stored in the buffer queue 8 is scheduled based on the traffic management database 3 by the packet scheduler 9.

In the case of a new session, namely, in the case where the packet is not a flow which is a target of the bandwidth guaranteeing, the packet of the control session is queued to the buffer queue 8 (in this case, best effort queue), and is copied by the packet classifier 5.

The packet copied by the packet classifier 5 is transmitted to the control session analyzing section 6.

The control session analyzing section 6 analyzes the packet from the packet classifier 5, and applies allocating of the bandwidth to the new buffer queue 8 for the reservation admission control section 7 when the port number and the required bandwidth of the data session which is assumed to be established later are recognized.

The reservation admission control section 7 judges the state of the internal resource, determines whether or not the traffic of the output line can guarantee the bandwidth of the data session based on the recognized port number and required bandwidth, and performs allocating of the bandwidth to the buffer queue 8 based on the determination result.

Further, the reservation admission control section 7 causes the packet scheduler 9 to perform scheduling of the packet based on the contents of the traffic management database 3.

When the allocating of the bandwidth to the buffer queue 8 can be performed and it is determined that the bandwidth guaranteeing is allowed, the reservation admission control section 7 adds and stores the flow and the queue ID of the buffer queue 8 newly allocated to the flow in the flow table 2.

At the same time, the reservation admission control section 7 updates and registers the flow and the bandwidth of the data session in the traffic management database 3.

When the allocating of the bandwidth cannot be performed, the reservation admission control section 7 controls such that the packet of the data session is buffered to the best effort queue of the buffer queue 8.

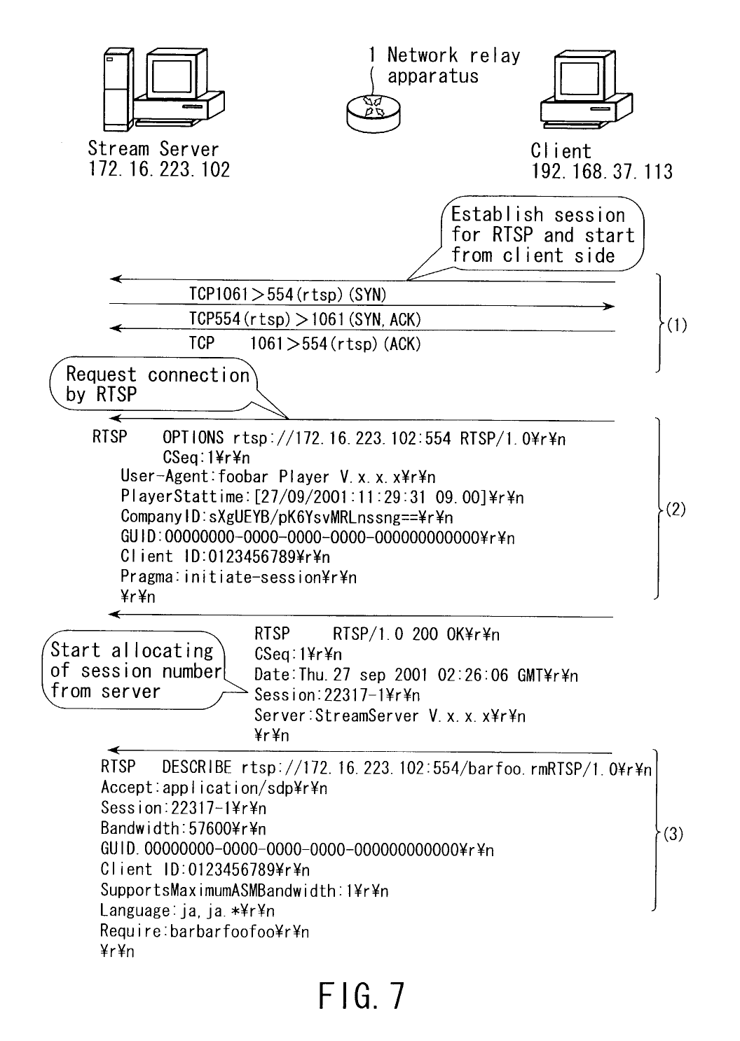

Next, one example of a specific bandwidth allocating method according to the relay apparatus 1 configured as described above will be explained with reference to FIGS. 7 to 11.

Item numbers (1) to (8) of the RTSP session operation examples described below correspond to item numbers (1) to (8) in FIGS. 7 to 9, respectively.

The initial states of the flow table 2 and the traffic management database 3 are the states shown in FIGS. 2 and 3, respectively.

(1) The establishment of the session for RTSP is started from the client side so that the RTSP port (554) of the server and the client are TCP-connected via the relay apparatus 1 according to the present embodiment.

At this time, the packet classifier 5 of the relay apparatus 1 according to the present embodiment detects that the destination port or the source port of the packet for the session establishment flowed from the server side at the TCP connection is the RTSP (554).

Further, the packet classifier 5 recognizes from the flow table 2 that the packet in which the RTSP (554) port is set to be the destination or the source has to be transmitted to the control session analyzing section 6.

Moreover, the packet classifier 5 stores the packet in the best effort queue of the buffer queue 8, and transmits it to the control session analyzing section 6 at the same time.

When the above packet is received, assuming that the RTSP session is newly established, the control session analyzing section 6 creates the temporary entry with the information of the IP address (192.168.37.113) and the port number (1061) of the client and the IP address (172.16.223.102) and the port number (554) of the server as identifiers, and stores it in the internal memory (not shown).

(2) The client applies a check of the option specification to the server (RTSP OPTIONS).

As with the processing of (1) described above, the packet classifier 5 stores the packet in the best effort queue of the buffer queue 8, and transmits it to the control session analyzing section 6 at the same time.

The control session analyzing section 6 recognizes that the above packet is the RTSP packet, and performs analysis dedicated to the RTSP.

Further, the control session analyzing section 6 recognizes that the bandwidth notification information is not included in the above RTSP packet, and ends the processing for the above packet.

Hereinafter, description of a series of operations when the operations are not directly associated with the bandwidth control will be omitted as the above processing.

(3) The client performs specification request of the contents for the server (RTSP DESCRIBE).

(4) The server sends the session information to the client (RTSP/SDP).

As with the processing of (1) described above, the packet classifier 5 stores the packet in the best effort queue of the buffer queue 8, and transmits it to the control session analyzing section 6 at the same time.

The control session analyzing section 6 recognizes that the bandwidth information of the contents is notified in the above RTSP/SDP packet.

In this case, the control session analyzing section 6 recognizes by the description (b=AS: 16) of the bandwidth information that the session requires the bandwidth with 16 Kbps from the server side to the client.

When the application for the stream is an application which is set in the pre-configured bandwidth by application in advance by the pre-configured bandwidth information database by application 4, the pre-configured bandwidth by application is used.

(5) The client requests the resource and the start of the RTSP session to the server (RTSP), and the server returns a reception response for the request to the client.

As with the processing of (1) described above, the packet classifier 5 stores the packet in the best effort queue of the buffer queue 8, and synchronously transmits it to the control session analyzing section 6.

The control session analyzing section 6 analyzes the above RTSP SETUP request packet, and recognizes the server port number (15794) for distribution and the protocol (UDP) to be used.

When it is determined from the above processing that the IP address and the port number of the server, the IP address and the port number of the client, the protocol, and the required bandwidth which are information required for the bandwidth reservation are acquired, the control session analyzing section 6 transfers these items of information to the reservation admission control section 7.

When it is confirmed from the flow table 2 that the existing connection is not present, the reservation admission control section 7 newly creates a dedicated queue (queue ID4) based on the information from the control session analyzing section 6, and performs setting of the required bandwidth (16 Kbps).

The reservation admission control section 7 sends the queue ID and the required bandwidth information to the traffic management database 3, and registers the corresponding entry.

The traffic management database 3 after this registration is changed from the state shown in FIG. 3 to the state shown in FIG. 11.

The reservation admission control section 7 sends the IP address and the port number of the server, the IP address and the port number of the client, the protocol, and the queue ID to the flow table 2, and registers the corresponding entry.

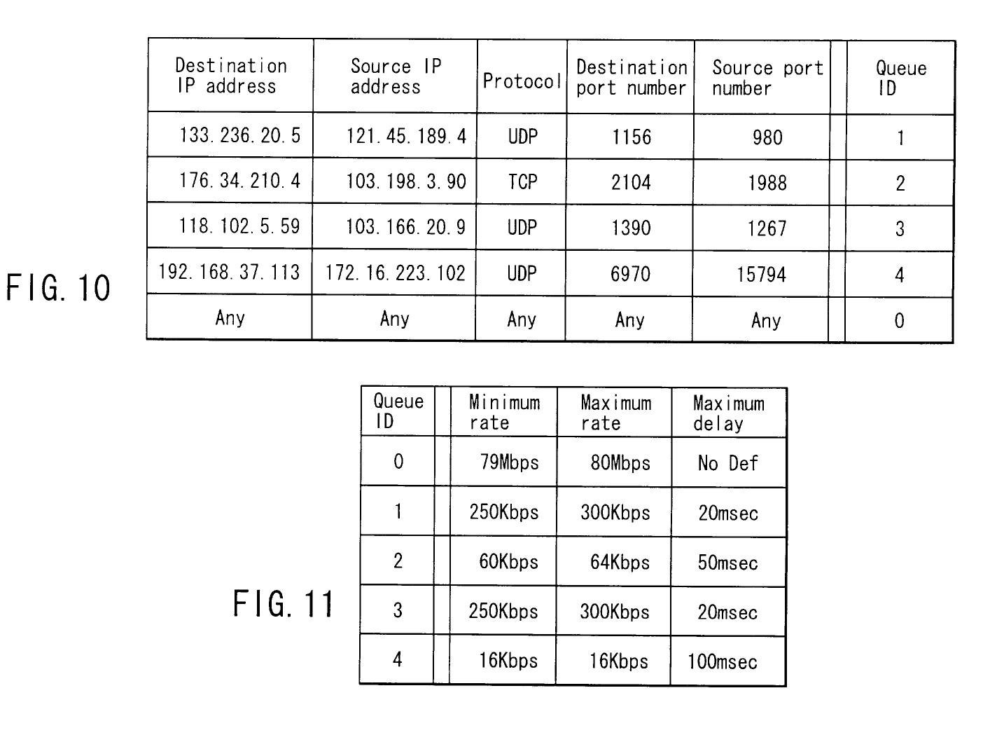

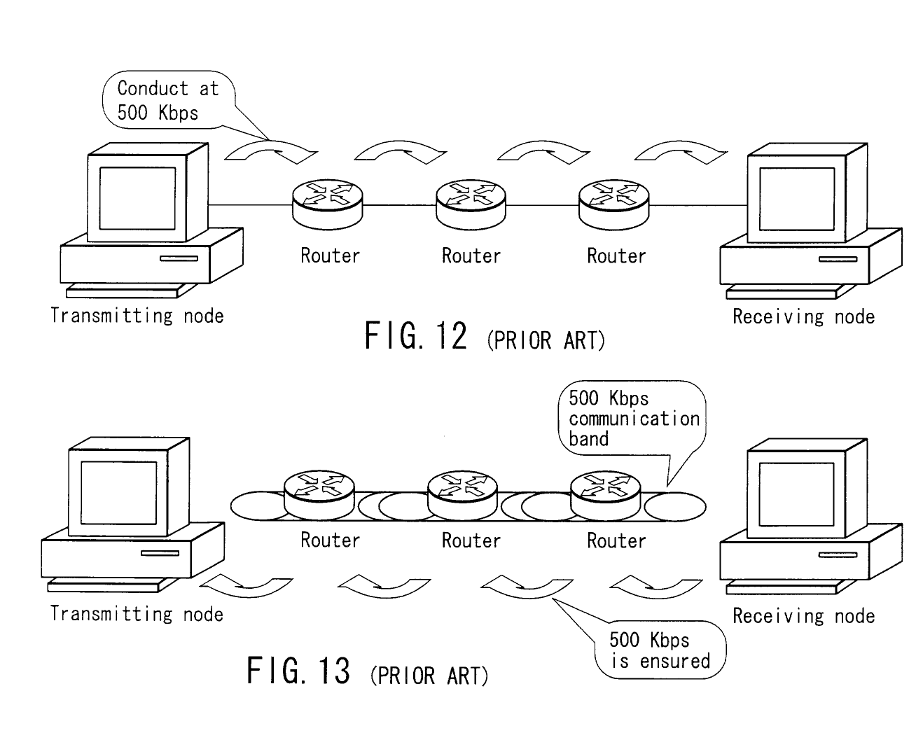

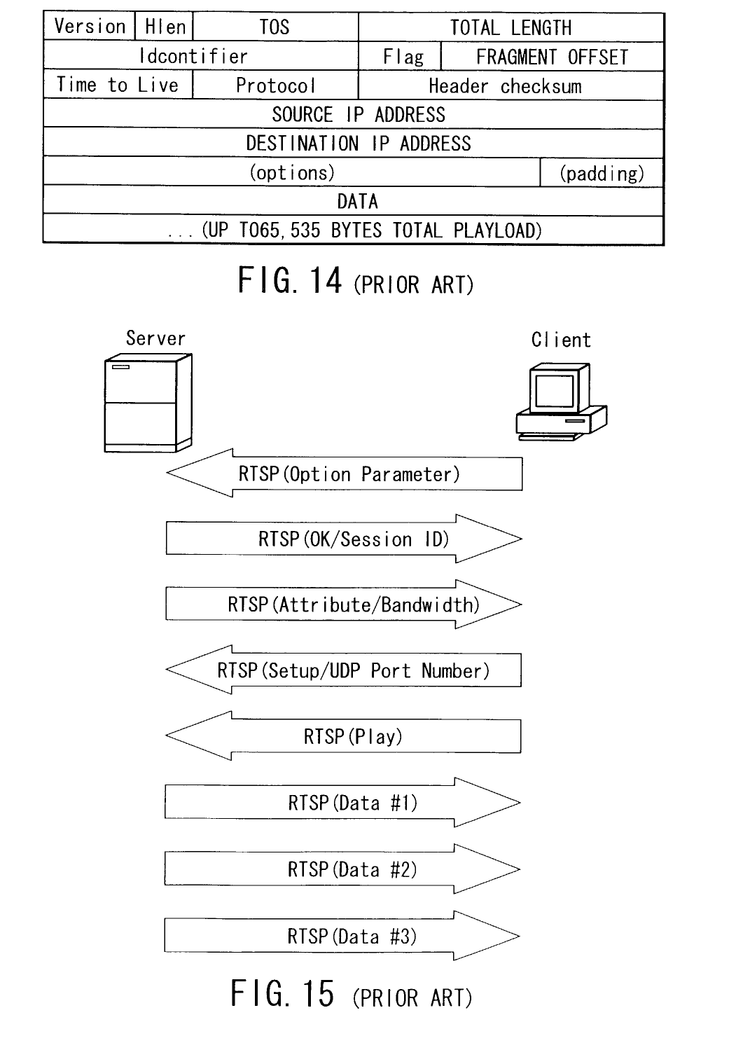

The flow table 2 after this registration is changed from the state shown in FIG. 2 to the state shown in FIG. 10.

(6) The client sends the parameter setting of the medium of the application to the server (RTSP SET_PARAMETER).

(7) The client requests the transmitting start of the medium of the application to the server (RTSP PLAY).

(8) The server starts the transmission of the stream data for the client.

The packet classifier 5 acquires the flow information of the packet of the stream data from the server.

The reservation admission control section 7 causes the packet scheduler 9 to output the above packet to the client based on the bandwidth information (16 Kbps) set in the traffic management database 3 of the queue ID4 by the comparison with the flow table 2.

Hereinafter, the queue is maintained until the disconnection of the TCP connection is detected or the timeout of the queue unused time is reached.

As described above, in the relay apparatus and relay method according to the present embodiment, while the fine bandwidth guaranteeing by flow of the RSVP is exploited, the disadvantage of the RSVP in which “the RSVP is not scaled” is compensated by the automatic detection of the bandwidth. In addition, for example, the bandwidth for video streaming, voice/video conference, or the like is read by exchange of the parameter during the session so that the bandwidth is automatically guaranteed.

In the relay apparatus and relay method according to the present embodiment, when the bandwidth is guaranteed, since the specific dedicated protocol such as the RSVP is not used and signaling for the connection is not required, a burden on user setting is not increased so that all the network appliances can be operated without the assumption all the network appliances are operated in some common framework.

Thereby, in the relay apparatus and relay method according to the present embodiment, the bandwidth can be automatically guaranteed by the buffer queue managed by the relay apparatus itself, or the bandwidth request value automatically detecting the line.

Further, in the apparatus and relay method according to the present embodiment, since the traffic is not aggregated to the PHB like the DiffServ and the respective bandwidths are guaranteed by flow, it is advantageous that required data is not dropped due to interference by other communication during congestion.

In the relay apparatus 1 of the present embodiment shown in FIG. 1, the packet classifier 5, the control session analyzing section 6, and the reservation admission control section 7 are shown as a separate structure, respectively, for simplifying the function of the input/output processing, but they may be configured as one processing section.

Furthermore, in the aforementioned embodiment, there is described the case of the application for stream distribution in which communication is performed using the RTSP and the RTP by way of example, but the relay apparatus and relay method according to the present invention can be applied when the required bandwidth and the port number can be recognized as the session information.

For example, the relay apparatus and relay method can be applied to a network conference using H.323.

In this network conference, the voice or the camera video can be communicated in real time using the Internet or LAN, and further, the network conference can be utilized as a videophone.

Further, the network conference performs call controlling and data exchanging by the communication protocol of H.323 of ITU-T recommendations including RTP for real time IP communication or low bit rate encoding technique (H.263, G.723.1).

H.323 defines a specification of transmitting/admission method of voice/video/data communication and a signaling method at calling on the LAN where the quality of service is not guaranteed, and further defines channels for data sharing such as file transfer, white board, and the like.

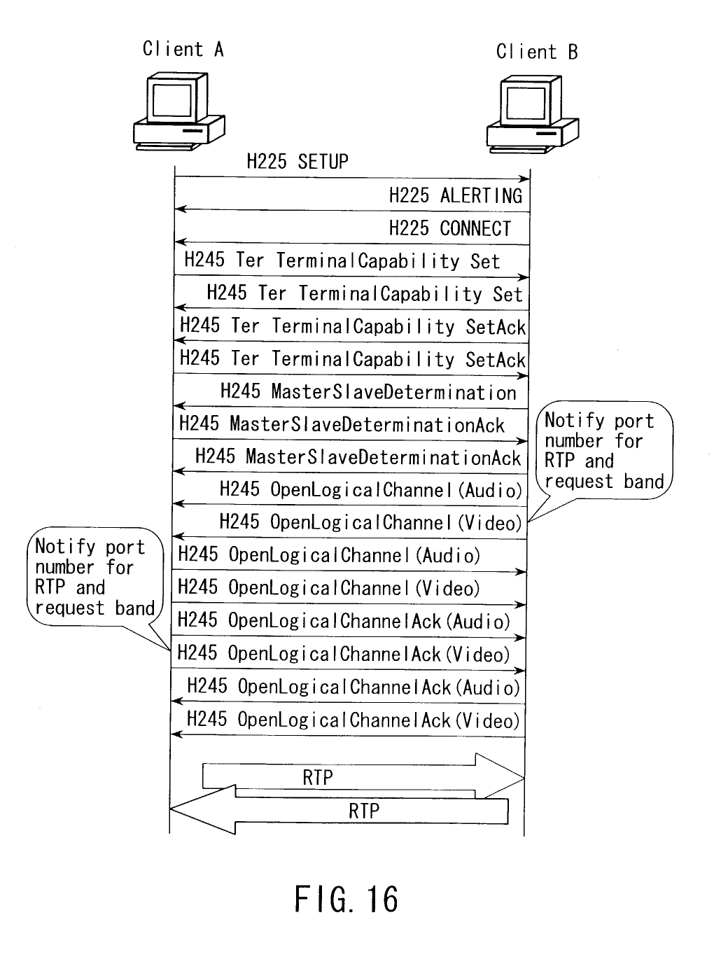

This H.323 is used as a protocol for a multimedia communication system and terminals in the network such as the Internet, LAN, and the like standardized by ITU-T recommendations in 1996, and performs establishing of calls and transmitting of data shown in FIG. 16.

In other words, as shown in FIG. 16, in this H.323, calling is controlled using H.225. 0 or H.245 on the TCP between the clients A and B, or video or voice is transmitted/received in real time by the RTP and the RTCP on the UDP after the connection is established.

In H.323, the UDP port number to be used for the RTP in Open Logical Channel and the bandwidth to be used are notified to the party on another side.

Therefore, when the relay apparatus and relay method according to the present invention are applied to the network conference using H.323, it is possible to monitor the UDP port number and the using bandwidth, and allocate the bandwidth of the internal buffer based on the monitoring result.

In addition, in the aforementioned embodiment, there is described the case where the control session and the data session are different flows with respect to the required bandwidth in the internal buffer by way of example, but the relay apparatus and relay method according to the present invention can be applied also when the control session is the same flow sharing for the data session, for example.

Further, in the example shown in FIGS. 7 to 11, the data flow is described as the port number, but when Ipv6 (internet protocol version 6) is employed, the flow label included in the header of the IP address is treated as a data flow.

The Ipv6 is defined in RFC2373, 2374, 2460-2472, and the like, and alleviates the processing loads of the routers by summarizing the path information when the address space is widen to 128 bits, and further typically comprises a security function by Ipsec, and an address automatic acquiring function by DHCP (dynamic host configuration protocol).

As can be seen from the above description, according to the present invention, while the fine bandwidth guaranteeing is achieved by flow as with the RSVP, it is possible to read the bandwidth for video streaming, voice/video conference, or the like from the parameter exchange during the session and to automatically ensure the bandwidth without the disadvantage that “the RSPV is not scaled” which the RSVP has due to the automatic detection of the bandwidth.

Additionally, according to the present invention, since, when the bandwidth is guaranteed, a specific dedicated protocol such as the RSVP is not used and signaling is not required, a burden on user setting is not increased so that all the network appliances can be operated without the assumption all the network appliances are operated in some common framework.

Consequently, according to the present invention, the bandwidth can be automatically guaranteed by the buffer queue managed by the relay apparatus itself or the bandwidth request value automatically detecting the line.

Further, according to the present invention, since the traffic is not aggregated to the PHB like the DiffServ but the respective bandwidths are guaranteed by flow, it is advantageous that required data is not dropped due to interference by other communication during congestion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus for relaying communication between two communication nodes, comprising:
a detecting section which monitors predetermined information included in communication contents transmitted from one node of the two communication nodes and detects bandwidth information associated with a required bandwidth for transmitting the communication contents from one node of the two communication nodes to another node;
a buffer group including buffer sections capable of guaranteeing the required bandwidth for transmitting the communication contents from one node of the two communication nodes to the other node;
a bandwidth allocating section which makes a determination on whether or not the required bandwidth can be guaranteed based on the bandwidth information detected by the detecting section, and the determination is that the required bandwidth can be guaranteed, allocates the buffer sections capable of guaranteeing the required bandwidth of the buffer group to the communication contents; and
a transmitting section which transmits the communication contents to the other node of the two communication nodes via buffer sections capable of guaranteeing the required bandwidth of the buffer group allocated by the bandwidth allocating section.

2. A communication apparatus according to claim 1, wherein, when communication is performed between the two communication nodes, the bandwidth allocating section includes a packet classifier which makes an identification on whether or not a packet included in the communication contents received via the one node is a flow which is a guaranteeing target of the required bandwidth, and a flow table having stored therein data indicating a correspondence relationship between the flow which is the guaranteeing target of the required bandwidth and an output queue of the buffer group, and
the packet classifier refers to the flow table to make identification on whether or not the packet is the flow which is the guaranteeing target of the required bandwidth, and stores the packet in buffer sections capable of guaranteeing the required bandwidth of the buffer group when the identification is that the packet is the flow which is the guaranteeing target of the required bandwidth.

3. A communication apparatus according to claim 2, wherein the transmitting section includes a packet scheduler which performs output scheduling based on data stored in a traffic management database in which data indicating a bandwidth and a delay required for transmitting the packet included in the communication contents allocated to the buffer sections capable of guaranteeing the required bandwidth is stored by queue ID of the flow table.

4. A communication apparatus according to claim 2, wherein the detecting section includes a control session analyzing section which detects information on the required bandwidth for a data session on reception of a packet of a control session from the packet classifier.

5. A communication apparatus according to claim 4, wherein the control session analyzing section makes a determination on whether or not the packet is a novel session, and extracts data session information based on the determination.

6. A communication apparatus according to claim 5, wherein the control session analyzing section makes a determination on whether or not an application is an application for pre-configured bandwidth setting based on a destination or source port number of the control session, and performs setting of the required bandwidth based on bandwidth information corresponding to a medium type of the data session information when the determination is that the application is an application for pre-configured bandwidth setting.

7. A communication apparatus according to claim 6, wherein the control session analyzing section refers to a pre-configured bandwidth information database by application having stored therein data indicating a pre-configured bandwidth predetermined according to each medium type, included in an application to be used to make a determination on whether or not an application with which a data session is exchanged is an application in which pre-configured bandwidth setting is performed, and performs setting of the required bandwidth using bandwidth information read from the pre-configured bandwidth information database by application based on the determination.

8. A communication apparatus according to claim 7, wherein the bandwidth allocating section includes a reservation admission control section which performs reservation admission control of the required bandwidth based on data session information input from the control session analyzing section.

9. A communication apparatus according to claim 8, wherein the reservation admission control section makes a determination on whether or not a required bandwidth included in data session information from the control session analyzing section is acceptable, when the determination is that the required bandwidth is acceptable, refers to a session list of the flow table to make a determination on whether or not the required bandwidth is an already reserved data session, and when the determination is that the required bandwidth is an already reserved data session, reserves the required bandwidth to perform resetting.

10. A communication apparatus according to claim 9, wherein the reservation admission control section makes a determination on whether or not the required bandwidth is acceptable by referring to used bandwidths registered in a traffic management database.

11. A communication method for relaying communication between two communication nodes, comprising:
monitoring predetermined information included in communication contents transmitted from one node of the two communication nodes and detecting bandwidth information associated with a required bandwidth for transmitting the communication contents from one node of the two communication nodes to another node;
preparing a buffer group including buffer sections capable of guaranteeing the required bandwidth for transmitting the communication contents from one node of the two communication nodes to the other node;
when a determination is made on whether or not the required bandwidth can be guaranteed based on the bandwidth information and the determination is that the required bandwidth can be guaranteed, allocating the communication contents to buffer sections capable of guaranteeing the required bandwidth of the buffer group; and
transmitting the communication contents to the other node of the two communication nodes via buffer sections capable of guaranteeing the required bandwidth of the buffer group.

12. A communication method according to claim 11, wherein, when communication is performed between the two communication nodes, the allocating makes an identification on whether or not a packet included in the communication contents received via the one node is a flow which is a guaranteeing target of the required bandwidth by referring to a flow table having stored therein data indicating a correspondence relationship between a flow which is a guaranteeing target of the required bandwidth and an output queue of the buffer group, and stores the packet in buffer sections capable of guaranteeing the required bandwidth of the buffer group when the identification is that the packet is a flow which is a guaranteeing target of the bandwidth.

13. A communication method according to claim 12, wherein the transmitting is performed by conducting output scheduling based on data in a traffic management database in which data indicating a bandwidth and a delay required for transmitting the packet included in the communication contents allocated to buffer sections capable of guaranteeing the required bandwidth is stored by queue ID of the flow table.

14. A communication method according to claim 12, wherein the detecting includes control session analysis for detecting information on the required bandwidth for a data session on reception of a packet of a control session included in the communication contents.

15. A communication method according to claim 14, wherein the control session analysis makes a determination on whether or not the packet is a novel session, and extracts data session information based on the determination.

16. A communication method according to claim 15, wherein the control session analysis makes a determination on whether or not an application is an application for pre-configured bandwidth setting based on a destination or source port number of the control session, and performs setting of the required bandwidth based on bandwidth information corresponding to a medium type of the data session information when the determination is that the application is an application for pre-configured bandwidth setting.

17. A communication method according to claim 16, wherein the control session analysis refers to a pre-configured bandwidth information database by application having stored therein data indicating a pre-configured bandwidth predetermined according to each medium type, included in an application to be used to determine whether or not an application with which a data session is exchanged is an application in which pre-configured bandwidth setting is performed, and performs setting of the required bandwidth using bandwidth information read from the pre-configured bandwidth information database by application.

18. A communication method according to claim 17, wherein the allocating performs reservation admission control of the required bandwidth based on data session information obtained by the control session analysis.

19. A communication method according to claim 18, wherein the reservation admission control makes a determination on whether or not a required bandwidth included in data session information obtained by the control session analysis is acceptable, when the determination is that the required bandwidth is acceptable, makes a determination on whether or not the required bandwidth is an already reserved data session by referring to a session list of the flow table and when the determination is that the required bandwidth is an already reserved data session, reserves the required bandwidth to perform resetting.

20. A communication method according to claim 19, wherein the reservation admission control makes a determination on whether or not the required bandwidth is acceptable by referring to used bandwidths registered in a traffic management database.
